(19) United States
(12) Patent Application Publication
(10) Pub. No.: US 2025/0254300 A1
(43) Pub. Date: Aug. 7, 2025

(54) Methods and Apparatus of CU Partition Using Signalling Predefined Partitions in Video Coding

(71) Applicant: MEDIATEK INC., Hsinchu City (TW)

(72) Inventors: Chih-Yao CHIU, Hsinchu City (TW); Hong-Hui CHEN, Hsinchu City (TW); Chun-Chia CHEN, Hsinchu City (TW); Shih-Ta HSIANG, Hsinchu City (TW); Chia-Ming TSAI, Hsinchu City (TW); Chih-Wei HSU, Hsinchu City (TW); Tzu-Der CHUANG, Hsinchu City (TW); Ching-Yeh CHEN, Hsinchu City (TW); Yu-Wen HUANG, Hsinchu City (TW)

(21) Appl. No.: 18/855,515

(22) PCT Filed: Apr. 11, 2023
(86) PCT No.: PCT/CN2023/087459

§ 371 Date: Oct. 9, 2024

Related U.S. Application Data
(60) Provisional application No. 63/330,343, filed on Apr. 13, 2022.

(51) Int. Cl. H04N 19/119; H04N 19/157; H04N 19/176; H04N 19/182; H04N 19/70

(52) U.S. Cl. CPC H04N 19/119; H04N 19/157; H04N 19/176; H04N 19/182; H04N 19/70

(57) ABSTRACT

Methods and apparatus for video coding. A current block is partitioned into one or more sub-blocks. The partitioning process comprises: signalling or parsing a first syntax where the first syntax is indicative of whether to split the current block; and in response to the first syntax indicating the current block being split, signalling or parsing a second syntax where the second syntax is indicative of whether to use a shortcut mode to indicate a target partition from predefined partitions directly. The sub-blocks are then encoded or decoded. According to another method, the partitioning process comprises signalling or parsing a first syntax where the first syntax is indicative of whether to split the current block; and in response to the first syntax, signalling or parsing a second syntax where the second syntax is indicative of one or more conditions comprising whether one of predefined partitions being applied to the current block.

### CROSS REFERENCE TO RELATED APPLICATIONS

The present invention is a non-Provisional Application of and claims priority to U.S. Provisional Patent Application No. 63/330,343, filed on Apr. 13, 2022. The U.S. Provisional Patent Application is hereby incorporated by reference in its entirety.

### FIELD OF THE INVENTION

The present invention relates block partition in a video coding system. In particular, the present invention relates to partitioning a block using a shortcut mode to indicate a target partition among predefined partitions.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows.

In the present invention, method and apparatus are disclosed to improve the efficiency of partition signalling.

### BRIEF SUMMARY OF THE INVENTION

A method and apparatus for video coding are disclosed. According to the method, pixel data associated with a current block at an encoder side or coded data associated with the current block to be decoded at a decoder side are received. The current block is partitioned into one or more sub-blocks. The partition process comprises: signalling or parsing a first syntax, wherein the first syntax is indicative of whether to split the current block; and in response to the first syntax indicating the current block being split, signalling or parsing a second syntax, wherein the second syntax is indicative of whether to use a shortcut mode to indicate a target partition from predefined partitions directly. Said one or more sub-blocks are encoded or decoded.

In one method, the method further comprised in response to the second syntax indicating the shortcut mode being applied to the current block, signalling or parsing a third syntax to indicate one of the predefined partitions being applied to the current block. In another method, the method further comprises in response to the third syntax indicating said one of the predefined partitions being applied to the current block, signalling or parsing a fourth syntax for each of sub-blocks generated by applying said one of the predefined partitions to the current block to indicate whether said each of sub-blocks is further partitioned.

According to another method, the partition process comprises: signalling or parsing a first syntax, wherein the first syntax is indicative of whether to split the current block; and in response to the first syntax, signalling or parsing a second syntax, wherein the second syntax is indicative of one or more conditions comprising whether one of predefined partitions being applied to the current block.

In one method, when the second syntax corresponds to a particular value, the current block is not partitioned using any of the predefined partitions.

In one embodiment, the second syntax is signalled or parsed when the first syntax indicates the current block being split. In one embodiment, the method further comprises in response to the second syntax indicating said one of predefined partitions being applied to the current block, signalling or parsing a third syntax for each of sub-blocks generated by applying said one of predefined partitions to the current block to indicate whether said each of sub-blocks is further partitioned. In one embodiment, when the second syntax is equal to the particular value, the current block is partitioned using one or more partition types comprising QT (Quadtree) partition, MTT (Multi-Type Tree) partition, or a combination thereof.

In one embodiment, the second syntax is signalled or parsed when the first syntax corresponds to false. In one embodiment, the method further comprises in response to the second syntax indicating said one of predefined partitions being applied to the current block, signalling or parsing a third syntax for each of sub-blocks generated by applying said one of predefined partitions to the current block to indicate whether said each of sub-blocks is further partitioned. In one embodiment, when the second syntax is equal to the particular value, the current block is not partitioned.

In one embodiment, said one or more conditions further comprise whether QT (quadtree) partition being applied to the current block. In one embodiment, when the second syntax corresponds to a first particular value, the current block is partitioned using QT (Quadtree) partition and when the second syntax corresponds to a second particular value, the current block is partitioned using MTT (Multi-Type Tree) partition.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of partitioning a picture into Coding Tree Units (CTUs).

FIG. 3 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 4 illustrates an example of the signalling mechanism of the partition splitting information in quadtree with nested multi-type tree coding tree structure.

FIG. 5 shows an example of a CTU divided into multiple CUs with a quadtree and nested multi-type tree coding block structure, where the bold block edges represent quadtree partitioning and the remaining edges represent multi-type tree partitioning.

FIG. 6 shows some examples of TT split forbidden when either width or height of a luma coding block is larger than 64.

FIG. 7 illustrates an example of new partition type according to an embodiment of the present invention, where one BT is followed by further splitting into TT or BT.

FIG. 8 illustrates an example of syntax signalling mechanism according to one embodiment of the present invention.

FIG. 9 illustrates an example of 2 predefined partitions.

FIG. 10 illustrates an example of 6 predefined partitions.

FIG. 11 illustrates an example of 14 predefined partitions.

FIG. 12 illustrates an example of syntax signalling mechanism according to another embodiment of the present invention.

FIG. 13 illustrates an example of syntax signalling mechanism according to yet another embodiment of the present invention.

FIG. 14 illustrates an example of syntax signalling mechanism according to yet another embodiment of the present invention.

FIG. 15 illustrates an example of new BT, which allows any kind of splitting boundary position.

FIG. 16 illustrates an example of arbitrary boundary concept where arbitrary boundary for TT and arbitrary boundary for QT can be used.

FIG. 17 illustrates an example of tilted partition.

FIG. 18 illustrates an example of partition into 2 parts: one is a corner-rectangular, another is remaining L-shape partition.

FIG. 19 illustrates an example of four-section partition by partitioning a parent CU into 4 sections, all in same cutting direction.

FIG. 20 illustrates an example of partition, where one CU is partitioned into 2 parts with one being a rectangle and the other part being the remaining samples.

FIG. 21 illustrates an example of 3D partitioning by grouping the temporal neighbouring samples together for coding. 5

FIG. 22 illustrates an example of splitting-flag prediction by neural-networks.

FIG. 23 illustrates a flowchart of an exemplary video coding system, which incorporates syntax signalling mechanism according to one embodiment of the present invention.

FIG. 24 illustrates a flowchart of an exemplary video coding system, which incorporates syntax signalling mechanism according to another embodiment of the present invention.

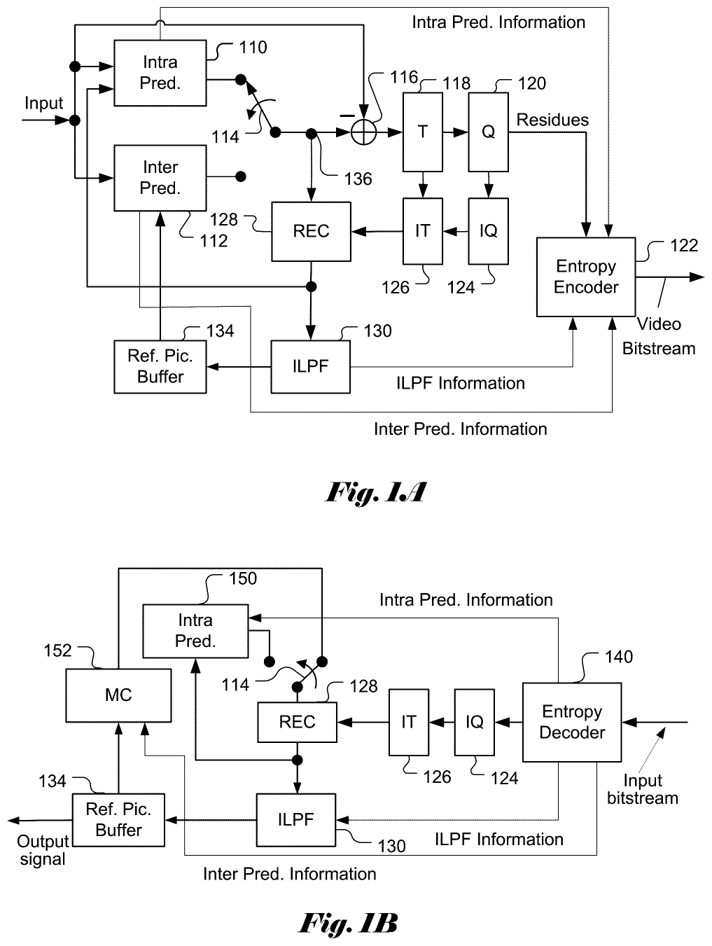

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by 30 way of example, and simply illustrates certain selected embodiments of apparatus and methods that are consistent with the invention as claimed herein.

### Partitioning of the CTUs Using a Tree Structure

Pictures are divided into a sequence of coding tree units (CTUs). The CTU concept is same as that for the HEVC. For a picture that has three sample arrays, a CTU consists of an N×N block of luma samples together with two corresponding blocks of chroma samples. FIG. 2 shows an example of a picture 210 divided into CTUs (shown as small squares) with 9 rows and 11 columns.

The maximum allowed size of the luma block in a CTU is specified to be 128×128 (although the maximum size of the luma transform blocks is 64×64).

In HEVC, a CTU is split into CUs by using a quaternary-tree or quadtree (QT) structure denoted as a coding tree to adapt to various local characteristics. The decision whether to code a picture area using inter-picture (temporal) or intra-picture (spatial) prediction is made at the leaf CU level. Each leaf CU can be further split into one, two or four PUs according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

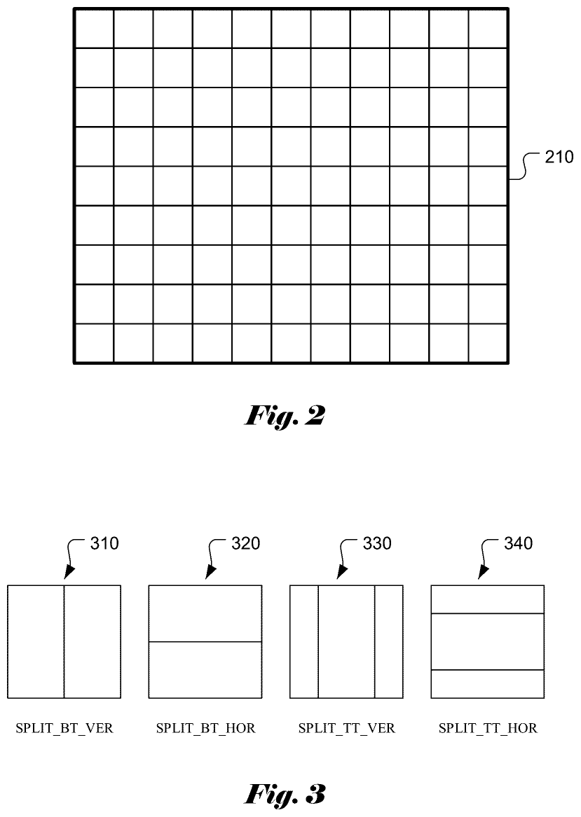

In VVC, a quadtree with nested Multi-Type Tree (MTT) using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 3, there are four splitting types in multi-type tree structure, vertical binary splitting (SPLIT_BT_VER 310), horizontal binary splitting (SPLIT_BT_HOR 320), vertical ternary splitting (SPLIT_TT_VER 330), and horizontal ternary splitting (SPLIT_TT_HOR 340). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

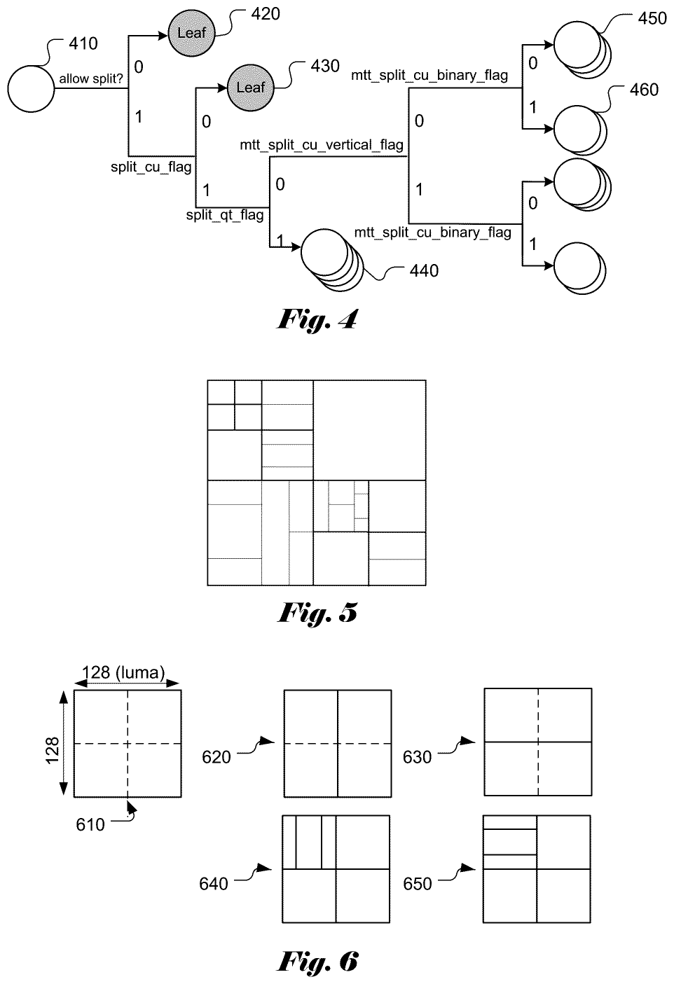

FIG. 4 illustrates the signalling mechanism of the partition splitting information in quadtree with nested multi-type tree. If the block is not allowed to split, a leaf node is reached and the block is CU (i.e., leaf 420). If the block is allowed to split, then a syntax split_cu_flag is signalled to indicated whether split is applied to the block. If the block is not split (i.e., path “0”), a leaf node is reached and the block is CU (e.g. leaf 430). A coding tree unit (CTU) 410 is treated as the root of a quaternary tree and is first partitioned by a quaternary tree structure. When syntax split_cu_flag indicates the block is split (i.e., path “1”), syntax split_qt_flag is signalled to indicate whether quadtree is used. If syntax split_qt_flag indicates the quadtree is used (i.e., path “1”), then the block is split into 4 sub-blocks 440. Each quaternary tree leaf node (when sufficiently large to allow it) is then further partitioned by a multi-type tree structure. In the multi-type tree structure, a first flag (mtt_split_cu_flag) is signalled to indicate whether the node is further partitioned; when a node is further partitioned, a second flag (mtt_split_cu_vertical_flag) is signalled to indicate the splitting direction, and then a third flag (mtt_split_cu_binary_flag) is signalled to indicate whether the split is a binary split or a ternary split. When the ternary split is applied, the block is split into 3 sub-blocks 450. When the binary split is used, the block is split into 2 sub-blocks 460. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derviation based on multi-type tree syntax elements

| MttSplitMode | mtt_split_cu_vertical_flag | mtt_split_cu_binary_flag |
|---|---|---|
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 5 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined and specified by SPS syntax elements for the quadtree with nested multi-type tree coding tree scheme.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinBtSize: the minimum allowed binary tree leaf node size
MinTtSize: the minimum allowed ternary tree leaf node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinBtSize and MinTtSize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 64×64). Otherwise, the leaf quadtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinBtSize and smaller or equal to 2*MinTtSize, no further horizontal splitting is considered. Similarly, when the multi-type tree node has height equal to MinBtSize and smaller or equal to 2*MinTtSize, no further vertical splitting is considered.

To allow 64×64 Luma block and 32×32 Chroma pipelining design in VVC hardware decoders, TT split is forbidden when either width or height of a luma coding block is larger than 64, as shown in FIG. 6, where block 610 represent a 128×128 block. TT split is also forbidden when either width or height of a chroma coding block is larger than 32. Block 620 corresponds to vertical binary split and block 630 corresponds to a horizontal binary split. Block 640 corresponds to the 128×128 block is split into four 64×64 blocks and the vertical TT split is applied to the upper-left 64×64 block. Block 650 corresponds to the 128×128 block is split into four 64×64 blocks and the horizontal TT split is applied to the upper-left 64×64 block.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

According to the statistics of CTU partitions based on many test sequences, we found that when the split type of a parent CU is horizontal binary split (HBT) or vertical binary split (VBT), the possibility of “split type of children CUs being no split” is pretty high. Therefore, we can take advantage of this correlation and propose to signal one or more shortcut syntaxes after the signalling of split_cu_flag for reducing the syntax overhead. Due to the high dependency of a current partition mode on the parent partition mode under certain conditions, it may be beneficial to use the shortcut mode to quickly determine the particular partition mode selected for the current block instead of going through multiple decision steps. Accordingly, several methods are disclosed in this application.

### Method 1: New Partition Short Cuts

In this proposed method, some new partition types are listed.

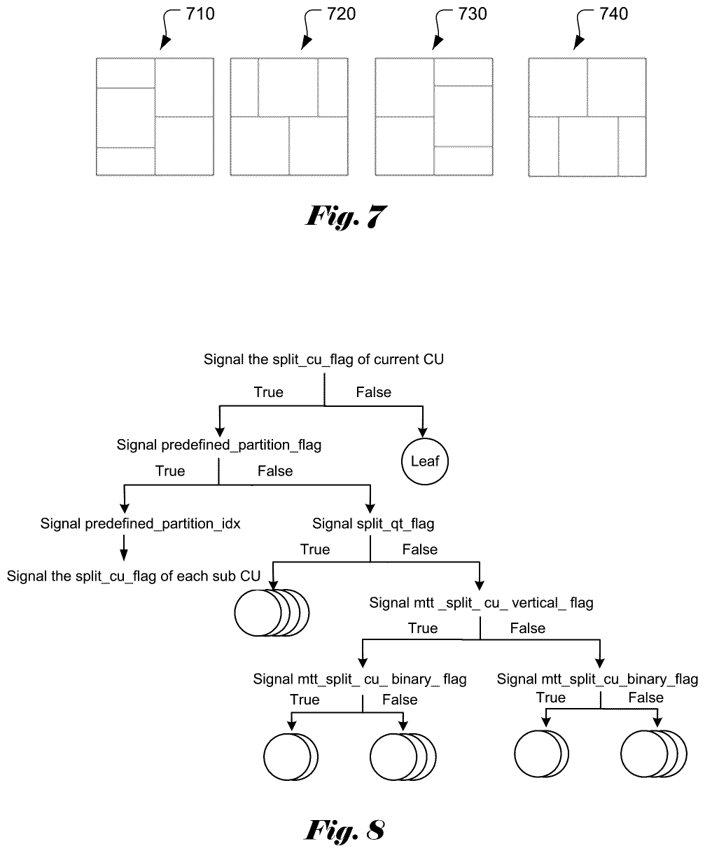

As shown in FIG. 7, a new partition type is proposed. In this partition, we have one BT followed by further splitting into TT or BT. However, instead of traditional VVC where we need to signal BT in depth-1 and then TT or BT in depth-2, the present method only uses one flag to represent 2 depths of BT/TT splitting result. For example, in FIG. 7, we can use one flag to represent this partition (referred as “double-depth TTBT partition”), if the partition is turned on, then, further bits can represent the particular direction among the four directions (710-740) as shown in FIG. 7.

In a more general way, encoder can firstly analyze which partition shape is most suitable for the content, and signal the choice of partition type in a picture header. For example, if after analysis, the partition in FIG. 7 is suitable, it can signal in header to tell decoder this partition is permitted to use. That is, encoder can perform statistical analysis to pick one or more complex partitions that haves higher probabilities to be selected. In some cases, a more complex partition (more complex than FIG. 7) can be predefined and sent in a picture header (for example, use one split step to reach 3-depth splitting for BT or TT), according to the current content. Therefore, the decoder can use it as an even shorter shortcut. While FIG. 7 illustrates an example of the predefined partitions, the set of partitions is not limited to this particular example. In the followings, more examples are illustrated for using predefined partitions, shortcut and signalling.

### Method 2

As mentioned in Method 1, the predefined partitions can be used when a block is split. When split_cu_flag is true (i.e., the CU being split in FIG. 4), one or more syntaxes can be signalled to specify whether any shortcut can be applied to represent the CU partition. If the shortcut is applied, for each sub-partition/sub-CU, we can define whether it can be further split. An embodiment of Method 2 is shown as follows:
Signal a flag to indicate whether a shortcut is applied or not.
If shortcut is applied, an index is further signalled to indicate which predefined partition is applied.

FIG. 8 illustrates an example of splitting flags signalling according to an embodiment of the present invention. When split_cu_flag is true, a short-cut syntax (e.g. predefined_partition_flag) can be signalled to indicate whether a shortcut is applied. If predefined_partition_flag is true, predefined_partition_idx is signalled to indicate a particular partition selected from predefined partitions. After knowing the partition, split_cu_flag is signalled for each sub-CU to indicate whether each sub-CU is further split or not. For the predefined partitions in FIG. 4, predefined_partition_idx can be used to indicate which of the four partitions is selected.

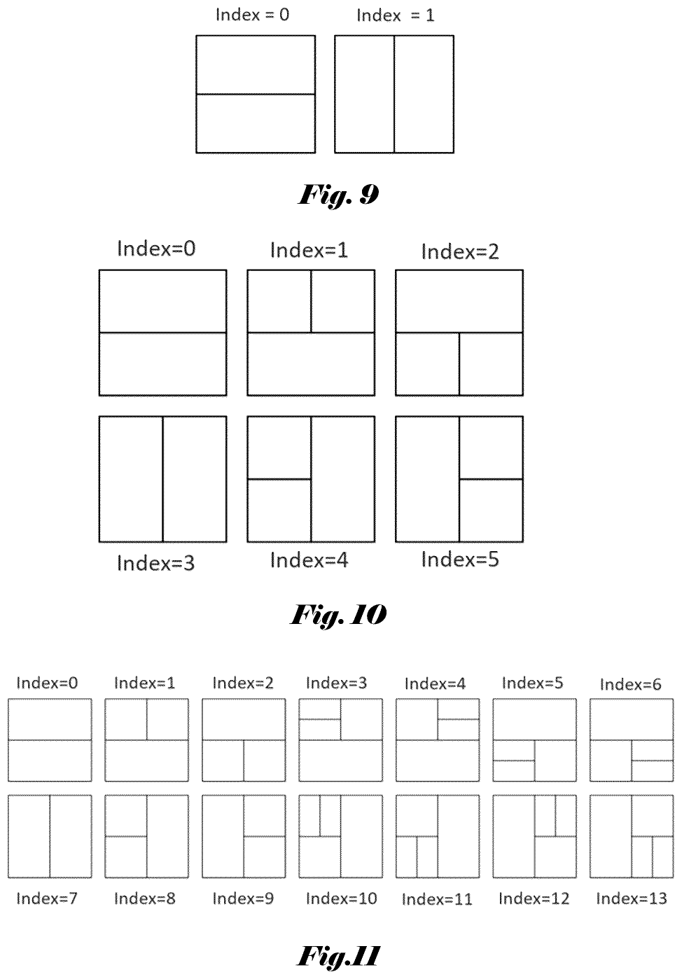

FIG. 9 illustrates another example of a set of predefined partitions according to an embodiment of the present invention. In this example, the predefined partition set comprises two partitions, where predefined_partition_idx=0 corresponds to a horizontal binary partition and predefined_partition_idx=1 corresponds to a vertical binary partition. FIG. 10 illustrates another example of set of predefined partitions, where the set comprises 6 partitions with the index from 0 to 5. FIG. 11 illustrates another example of set of predefined partitions, where the set comprises 14 partitions with the index from 1 to 13. Embodiments of predefined_partition_idx as shown in FIG. 9 to FIG. 11 are intended for illustration of predefined partition sets. They should not be construed as limitations to the present invention. Furthermore, different encode algorithms such as truncated unary instead of fixed length coding can be applied to encode the predefined_partition_idx. The additional syntaxes can be incorporated into an existing coding tree syntax table. For example, the syntax table according to this embodiment based on VVC, as shown in Table 2, can be formed by modifying the syntax table of the conventional approach.

TABLE 2
Exemplary coding tree syntax for Method 2 according to one embodiment

| | Note_A |
|---|---|
| if( split_cu_flag ) { | |
| predefined_partition_flag | (1) |
| if( predefined_partition_flag ) { | (2) |
| predefined_partition_idx | |
| } | (3) |
| else{ | (4) |
| if( ( allowSplitBtVer \| \| allowSplitBtHor \| \| allowSplitTtVer \| \| allowSplitTtHor ) && | |
| allowSplitQt ) | |
| split_qt_flag | |
| if( !split_qt_flag ) { | |
| if( ( allowSplitBtHor \| \| allowSplitTtHor ) && ( allowSplitBtVer \| \| allowSplitTtVer ) ) | |
| mtt_split_cu_vertical_flag | |
| if( ( allowSplitBtVer && allowSplitTtVer && mtt_split_cu_vertical_flag ) \| \| | |
| ( allowSplitBtHor && allowSplitTtHor && !mtt_split_cu_vertical_flag ) ) | |
| mtt_split_cu_binary_flag | |
| } | |
| ... ... | (5) |
| } | |
| } | |

As shown in Table 2, a new syntax, predefined_partition_flag is added as indicated by Note_A (1). If predefined_partition_flag is true, another new syntax, predefined_partition_idx is added as indicated between Note_A (2) and Note_A (3). Otherwise, (i.e., predefined_partition_flag being false), the conventional splitting tree syntaxes are used as shown between Note_A (4) and Note_A (5).

In Table 2, predefined_partition_flag equal to 1 specifies that the partition of current CU is one of the predefined partition. predefined_partition_flag equal to 0 specifies that the partition of current CU is not one of the predefined partitions. predefined_partition_idx specifies which predefined partition the current CU belongs to.

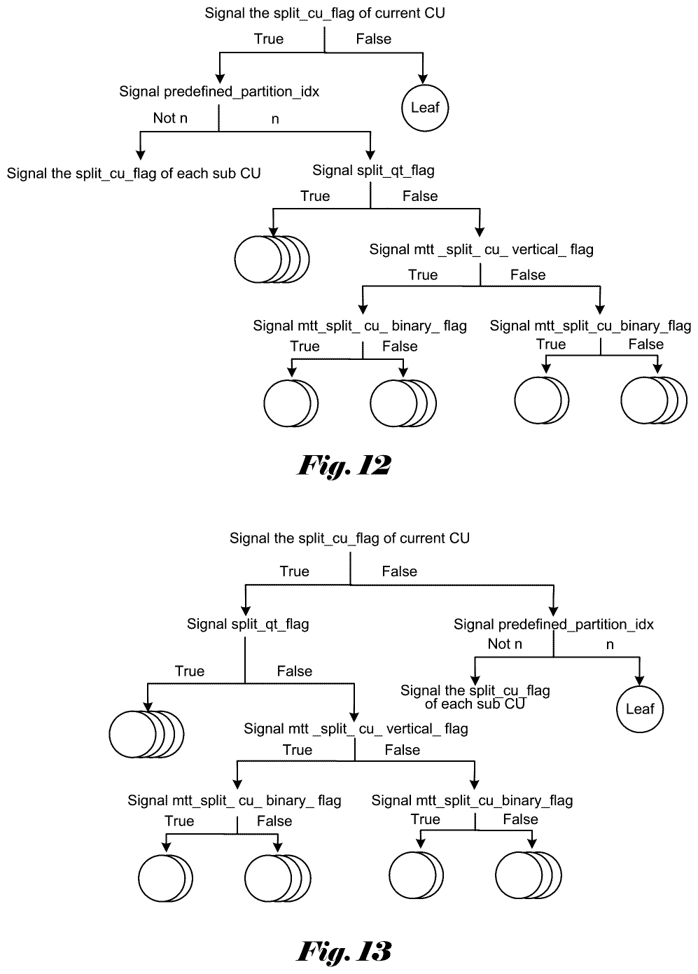

According to a second embodiment of Method 2, we simply remove the predefined_partition_flag and change the definition of predefined_partition_idx. When predefined_partition_idx equals n, it means that the partition of current CU is not one of the predefined partitions and we need to signal split_qt_flag as shown in FIG. 12. In contrast, when predefined partition_idx doesn't equal n, the value of predefined_partition_idx represents one of the predefined partitions. We propose to use variable length coding to encode predefined_partition_idx. Thus, we need to collect statistics of the CU partition. The syntax signalling mechanism is shown in Table 3.

TABLE 3
Exemplary coding tree syntax for Method 2 according to another embodiment

| | Note_B |
|---|---|
| if( split_cu_flag ) { | |
| predefined_partition_idx | (1) |
| if( predefined_partition_idx = = n){ | (2) |
| if( ( allowSplitBtVer \| \| allowSplitBtHor \| \| allowSplitTtVer \| \| allowSplitTtHor ) && | |
| allowSplitQt ) | |
| split_qt_flag | |
| if( !split_qt_flag ) { | |
| if( ( allowSplitBtHor \| \| allowSplitTtHor ) && ( allowSplitBtVer \| \| | |
| allowSplitTtVer ) ) | |
| mtt_split_cu_vertical_flag | |
| if( ( allowSplitBtVer && allowSplitTtVer && mtt_split_cu_vertical_flag ) \| \| | |
| ( allowSplitBtHor && allowSplitTtHor && !mtt_split_cu_vertical_flag ) ) | |
| mtt_split_cu_binary_flag | |
| } | |
| ... ... | |
| } | (3) |
| } | |

As shown in Table 3, new syntax, predefined_partition_idx is added as indicated in Note_B (1). When predefined_partition_idx is equal to n, the conventional splitting tree syntaxes starting from split_qt_flag are used as shown between Note_B (2) and Note_B (3).

### Method 3

In this method, we propose to change the semantics of split_cu_flag as follows:
When split_cu_flag is equal to 1, it means that the current CU can be further split and the partition of current CU is not one of the predefine partitions.
When split_cu_flag is equal to 0, it means that the current CU can't be further split or the partition of current CU is one of the predefine partitions.

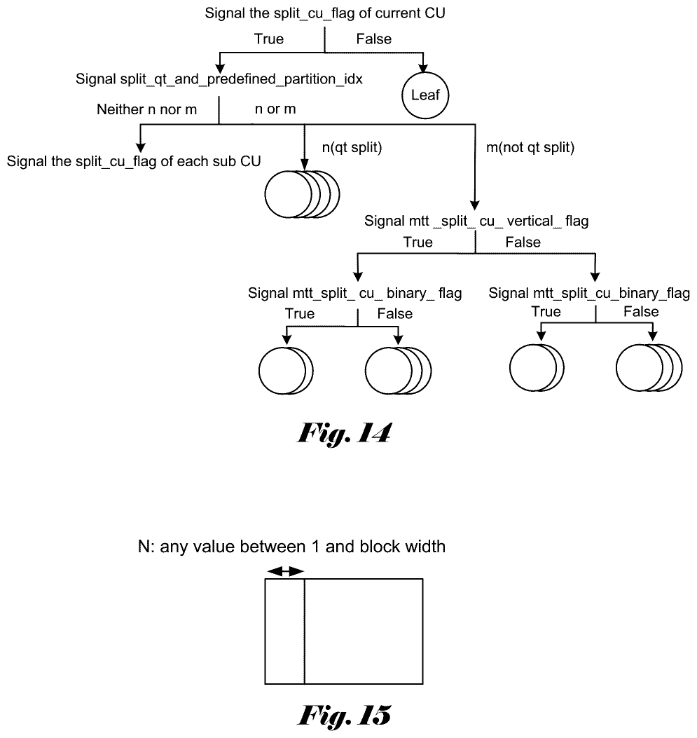

We further signal predefined_partition_idx to specify the partition of the current CU when split_cu_flag is equal to 0 (i.e., False) as shown in FIG. 13. When predefined_partition_idx is equal to n, it means that current CU is not further split. The n corresponds to a predefined value, such as a positive integer.

Syntax predefined_partition_idx specifies which predefined partition of the current CU belongs to when it is not equal to n. If the CU size is too small to be split, the decoder can derive the value of split_cu_flag and predefined_partition_idx. We propose to use variable length coding to encode predefined_partition_idx. Thus, we need to collect statistics of the of CU partition. If predefined_partition_idx is not equal to n, for each sub-partition/sub-CU, we can define whether it can be further split by signalling split_cu_flag for each sub-partition/sub-CU.

An example of syntax table corresponding to this embodiment is shown in Table 4.

TABLE 4
Exemplary coding tree syntax for Method 3 according to one embodiment

| | Note_C |
|---|---|
| if( split_cu_flag ) { | |
| if( ( allowSplitBtVer \| \| allowSplitBtHor \| \| allowSplitTtVer \| \| allowSplitTtHor ) && | |
| allowSplitQt ) | |
| split_qt_flag | |
| if( !split_qt_flag ) { | |
| if( ( allowSplitBtHor \| \| allowSplitTtHor ) && ( allowSplitBtVer \| \| allowSplitTtVer ) ) | |
| mtt_split_cu_vertical_flag | |
| if( ( allowSplitBtVer && allowSplitTtVer && mtt_split_cu_vertical_flag ) \| \| | |
| ( allowSplitBtHor && allowSplitTtHor && !mtt_split_cu_vertical_flag ) ) | |
| mtt_split_cu_binary_flag | |
| } | |
| ... ... | |
| } // end of if( split_cu_flag ) | |
| else{ | (1) |
| predefined_partition_idx | (2) |
| } | (3) |

As shown in Table 4, when split_cu_flag is false, a new syntax, predefined_partition_idx is added as indicated between Note_C (1) and Note_C (3).

### Method 4

According to this method, we simply remove the predefined_partition_flag and combine predefined_partition_idx and split_qt_flag into a new syntax, split_qt_and_predefined_partition_idx. When split_qt_and_predefined_partition_idx equals n, it means that the partition of current CU is not one of the predefined partitions and quadtree split is applied to current CU. When split_qt_and_predefined_partition_idx equals m, it means that the partition of current CU is not one of the predefined partitions and quadtree split is not applied to current CU. split_qt_and_predefined_partition_idx specify that which predefined partition of current CU belongs to when it is not equal to n and not equal to m. Again, n and m correspond to predefined values, such as two different integer values. We propose to use variable length coding to encode split_qt_and_predefined_partition_idx. Thus, we need to collect statistics of CU partition.

An example of syntax signalling corresponding to Method 4 is illustrated in FIG. 14. As shown in FIG. 14, the combined syntax split_qt_and_predefined_partition_idx is signalled when of split_cu_flag is true. When split_qt_and_predefined_partition_idx is not equal to n and not equal to m, split_cu_flag is signalled for each sub-CU. When split_qt_and_predefined_partition_idx is equal to n, quadtree split is applied. When split_qt_and_predefined_partition_idx is equal to m, non-quadtree split is applied.
split_qt_and_predefined_partition_idx equal to n specifies that the partition of current CU is not one of the predefined partitions and quadtree split is applied to current CU. split_qt_and_predefined_partition_idx equal to m specifies that the partition of current CU is not one of the predefined partitions and quadtree split is not applied to current CU.
split_qt_and_predefined_partition_idx specify that which predefined partition of current CU belongs to when it is neither n nor m.

TABLE 5
Exemplary coding tree syntax for Method 4 according to one embodiment

| | Note_D |
|---|---|
| if( split_cu_flag ) { | |
| if( ( allowSplitBtVer \| \| allowSplitBtHor \| \| allowSplitTtVer \| \| allowSplitTtHor ) && | |
| allowSplitQt ) | |
| split_qt_flag split_qt_and_predefined_partition_idx | (1) |
| if( !split_qt_flag ) if( split_qt_and_predefined_partition_idx = = m){ | (2) |
| if( ( allowSplitBtHor \| \| allowSplitTtHor ) && ( allowSplitBtVer \| \| allowSplitTtVer ) ) | |
| mtt_split_cu_vertical_flag | |
| if( ( allowSplitBtVer && allowSplitTtVer && mtt_split_cu_vertical_flag ) \| \| | |
| ( allowSplitBtHor && allowSplitTtHor && !mtt_split_cu_vertical_flag ) ) | |
| mtt_split_cu_binary_flag | |
| } | |
| ... ... | |
| } | |

An example of syntax table corresponding to method 4 is shown in Table 5, where texts in Italic correspond to deleted texts. As shown in Table 5, syntax split_qt_flag is replaced by split_qt_and_predefined_partition_idx as shown in Note_D (1). Furthermore, the statement “if (!split_qt_flag)” is replaced by “if (split_qt_and_predefined_partition_idx==m)” as shown in Note_D (2).

### Method 5: Arbitrary Boundary of BT

In this proposed method, one new type of BT (Binary Splitting) is proposed. Instead of conventional BT, the new BT can have any kind of splitting boundary position, as shown in FIG. 15. For example, if the CU is 32×32, the arbitrary horizontal BT will partition into 2 sub-CU, with one equal to 32×N and another equal to 32×(32−N), where N is the value of between 1 to 32.

In one sub-embodiment, the partition position (i.e., the N value) can be signalled from encoder to decoder. In another sub-embodiment, it can be derived at the decoder side by some template-matching methods.

This new form of BT will be beneficial for a lot of contents because object boundary is commonly aligned with the middle of the parent CU (i.e., conventional VBT, HBT case will not perfectly match).

In the arbitrary boundary of BT, to save the syntax overhead, in one sub-embodiment, it can turn on/off for this kind of splitting for different CTU/CTU-Row/Tile/Slice/Picture.

In the BT with arbitrary boundary, to simplify the transform algorithm, it can restrict to apply the “arbitrary boundary BT” only to skip mode in one sub-embodiment.

In the arbitrary boundary BT, to simplify the intra-prediction algorithm, it can restrict to apply the “arbitrary boundary BT” only to inter mode in one sub-embodiment. In another embodiment, some splitting dimension will not be allowed for intra-coding (e.g. if the 32×32 split into 7×32 and 25×32→intra coding not allowed, but if 32×32 split to 16×32 and 16×32→intra-coding allowed)

In the arbitrary boundary BT, to simplify the transform algorithm, the residual block can be padded to fit the transform kernel size in one sub-embodiment. For example, if the sub-CU is 7×16, then we originally need one 7×16 transform kernel. However, according to an embodiment of the present invention, we can pad for the 7×16 to be 8×16 so that the transform kernel of size 8×16 can be applied.

### Method 6: Arbitrary Boundary of Splitting

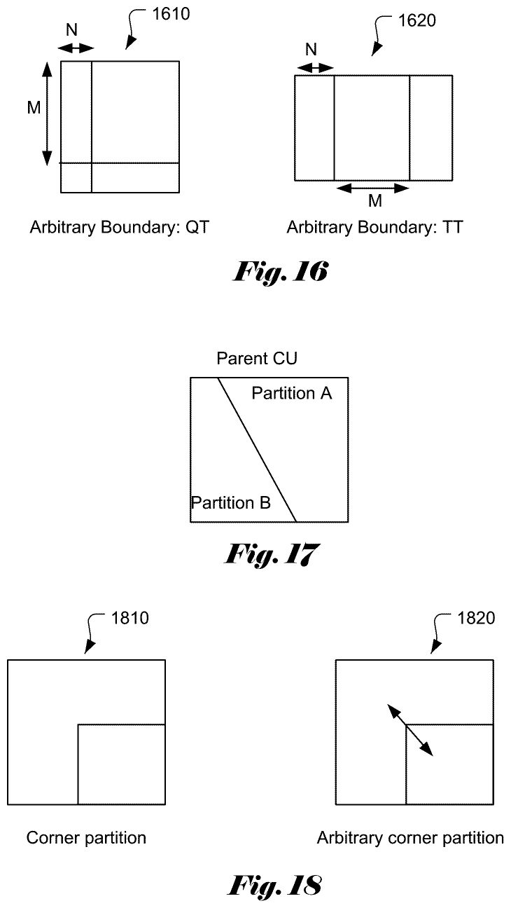

This method is to apply arbitrary boundary concept (similar to method 5) to other type of partition, such as arbitrary boundary for TT (1610) and arbitrary boundary for QT (1620) as shown in FIG. 16, where N and M values can be arbitrary.

In one sub-embodiment, the partition position (i.e., the N or M value as before) can be signalled from the encoder to the decoder. In another sub-embodiment, it can be derived in the decoder side by some template-matching methods.

We can also adopt the transform simplification or intra prediction simplification methods in Method 5 into the Method 6.

### Method 7: GPM-Like Partition

In this method, the parent CU is partitioned into 2 parts, the partition boundary can be tilted (i.e., non-horizontal boundary or non-vertical boundary), as shown in FIG. 17. The partition method is similar to VVC's GPM mode. The partitions A and B are different CUs and separate coding flow, such as coding mode, candidate-list, residual coding (e.g. it can use shape-adaptive DCT for the transform part) can be applied.

For the content-dependent characteristics, in one embodiment, it uses Picture/Tile/Slice/CTU-row/CTU header to control On-Off for the GPM-partition type. For example, the encoder can perform picture analysis (e.g. MV field analysis) to guess whether to turn on the GPM CU-partition or not.

Moreover, it is further proposed to have one GPM-TT partition., In other words, the partition is based on TT partition, and however the splitting boundary can be tilted.

### Method 8: Corner Partition

In this method, one parent CU is partitioned into 2 parts (1810): one is a corner-rectangular, another is remaining L-shape partition as shown in FIG. 18. The ratio between parent block and corner-block can be 2:1, 4:1 or other ratio.

In another sub-embodiment, applying arbitrary boundary concept, as in partition 1820 in FIG. 18.

In one sub-embodiment, the partition position (i.e., the N or M value as before) can be signalled from the encoder to the decoder. In another sub-embodiment, it can be derived in the decoder side by some template-matching methods.

The residual transform of L-shape partition can be:
Sub-embodiment 1: Padded into a rectangular and transformed by conventional transform
Sub-embodiment 2: Partitioned into 2 rectangular sub-residual-block and performing transform separately
Sub-embodiment 3: One special-designed L-shape transform kernel

We can also adopt the transform simplification or intra-prediction simplification methods in Method 5 into the “arbitrary boundary part in Method 8”.

### Method 9: Other Brute-Force Partitions

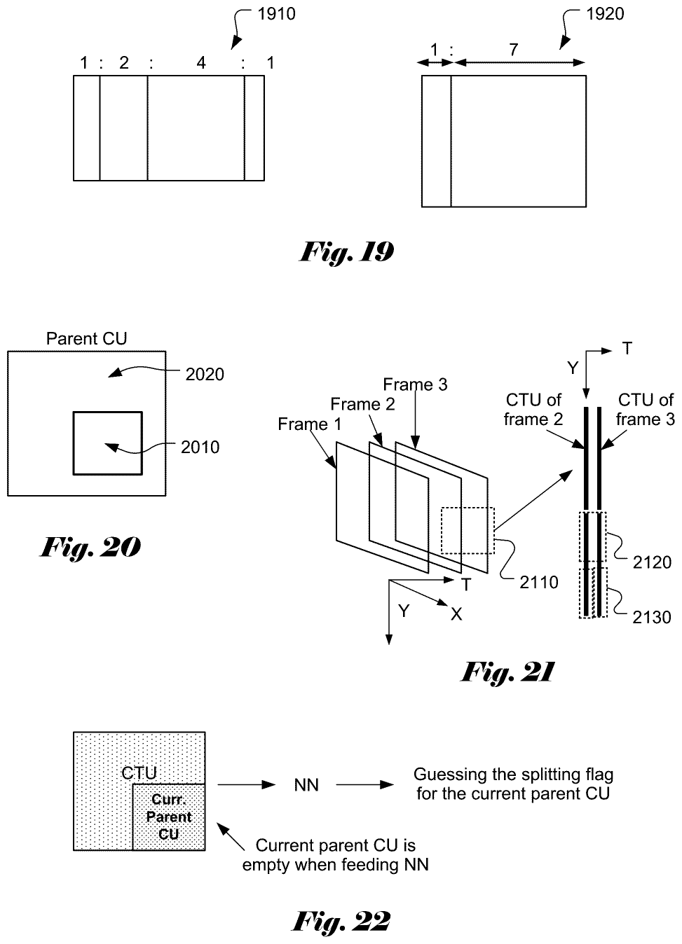

More partition types are proposed. In one embodiment, 7:1 or 1:7 BT is used. This method can apply to HBT or VBT. An example of 1:7 (1920) is shown in FIG. 19 for the 1:7 VBT case. Other ratios of partition can also be used (e.g. 15:1, 1:15, 31:1, 1:32, . . . ).

An example of four-section partition is disclosed by partitioning a parent CU into 4 sections all in same cutting direction. One example (1910) is shown in FIG. 19. It can be horizontal-cutting based or vertical-cutting based (e.g. partition 1910 in FIG. 19).

Some examples of ratios between the 4 sections are shown:
[A] 1:2:4:1
[B] 1:4:2:1
[C] 4:2:1:1
[D] 1:1:2:4

Other orders can also be applied.

### Method 10: Block Inside Large Block

In this method, one “block inside large block” partition proposed. As shown in FIG. 20, one CU is partitioned into 2 parts (2010 and 2020), one is a rectangle (2010) and the other part is the remaining samples (2020).

This partition can be beneficial for coding gain, for some special contents, it is not easy to approach with good coding gain for old BT/QT/TT, but very suitable for “block inside large block” partition.

In one sub-embodiment, the inner-rectangular position (offset related to left-top corner of parent) can be signalled from encoder to decoder. In another sub-embodiment, it can be derived in the decoder side by some template-matching methods.

Some methods are proposed for the surrounding-samples partition residual part:
Sub-embodiment 1: Padded into a rectangular and transformed by conventional transform
Sub-embodiment 2: Partitioned into several rectangular sub-residual-block and doing transform separately
Sub-embodiment 3: One special-designed surrounding transform kernel

### Method 11: 3D-Based Partition

Instead of traditional CU partitioning where the spatial neighbouring samples are grouped together for coding, the present proposed method groups the temporal neighbouring samples together for coding. The partition can be not only 2D (spatial neighbouring samples, in coordinate X, Y), but also in 3D (spatial (X,Y) with temporal (coordinate: T)) grouping. As shown in FIG. 21, one coding unit can include not only samples inside the same frame (e.g. frame 1), but can also include samples (2110) of 2 consecutive frames (e.g. frames 2 and 3). In another embodiment, it may include more consecutive frames. The tree-partition will be 3-D based, it can partition the samples into subblocks in temporal-direction (i.e., T-coordinate) and spatial-direction (i.e., X, Y coordinates). The samples from frames 2 and 3 may be used with temporal combined coding (2120) or without temporal combined coding (2130).

The Benefit is that, in some still-background, 3D-based transform will be better than conventional 3D-based video coding.

The 3D-tree-partition can be turned on/off based on N-frame-level, or tile-level, or even CTU-level. The splitting order can be temporal splitting first then spatial splitting. In another way, spatial splitting is performed first and then temporal splitting.

### Method 12: Splitting-Flag Prediction by Neural-Networks

The neural network is one emerging technique for circuits or algorithm, using some neural units (neurons) to connect into one network. It is powerful for doing image analysis, image recognition and so on.

In this method, we propose to use the neural network to predict the splitting flags for one parent CU, the input for the neural network is a large range of pixels of neighbouring samples of current “parent-CU”, and the output of the neural network is the estimated prediction results for splitting flags inside the “parent-CU”. The current “parent-CU” is the current region to-be-predicted for the splitting flags, the predicted splitting flags will help the decoder to know how to split the current “parent-CU”. Note that, the proposed scheme is applied in the decoder side. In other words, the NN (Neural network) needs to be applied on the decoder side.

In the decoder side, there are 2 sub-embodiments when it gets the prediction results for the splitting information by NN.
Sub-embodiment 1: the prediction results are directly applied, but with restricted splitting information. In other words, only part of the splitting information is predicted, and other information is sent by the encoder. For example, the encoder can send only BT (but not telling the decoder HBT or VBT), and the HBT or VBT judgement is totally dependent on the NN analysis.
Sub-embodiment 2: the prediction results are referred as reordering priority. In other words, all the splitting directions are reordered based on the NN analysis, and the encoder needs to send the decoder one reorder index. For example, the encoder sends index 0, and the HBT and VBT is firstly sorted by NN prediction results. If after sorting, HBT is better than VBT, then HBT means index 0, VBT means index 1.

The benefit of proposed method is for saving syntax rates for splitting flags.

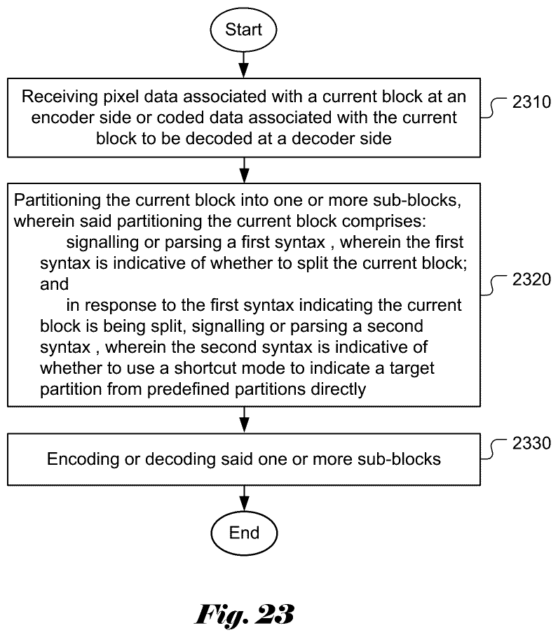

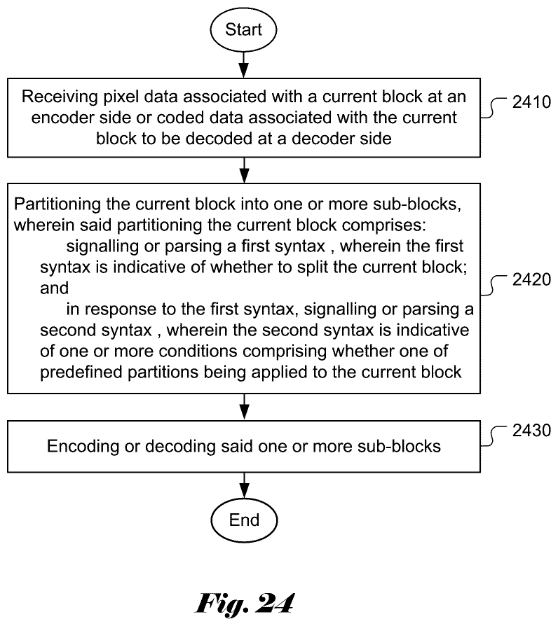

As shown in FIG. 22, the NN input is the entire CTU range (except for the current Parent CU region, which is not available since it is not decoded yet). After the NN analysis, the splitting flags are predicted (or assisted for prediction), and the “current parent CU” can be further split based on the predicted splitting flags.

The foregoing proposed shortcut signalling method can be implemented in encoders and/or decoders. For example, the proposed method can be implemented in an inter coding module of an encoder, and/or an inter coding module of a decoder. For example, the proposed method can be implemented in an intra coding module of an encoder, and/or an intra coding module of a decoder. For example, the proposed method can be implemented in a tree-splitting coding module of an encoder, and/or a tree-splitting coding module of a decoder. Furthermore, signalling related to the proposed methods may be implemented using Entropy Encoder 122 in the encoder or Entropy Decoder 140 in the decoder.

FIG. 23 illustrates a flowchart of an exemplary video coding system, which incorporates syntax signalling mechanism according to one embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, pixel data associated with a current block at an encoder side or coded data associated with the current block to be decoded at a decoder side are received in step 2310. In step 2320, the current block is partitioned into one or more sub-blocks, wherein said partitioning the current block comprises: signalling or parsing a first syntax, wherein the first syntax is indicative of whether to split the current block; and in response to the first syntax indicating the current block being split, signalling or parsing a second syntax, wherein the second syntax is indicative of whether to use a shortcut mode to indicate a target partition from predefined partitions directly. Said one or more sub-blocks are encoded or decoded in step 2330.

FIG. 24 illustrates a flowchart of an exemplary video coding system, which incorporates syntax signalling mechanism according to another embodiment of the present invention. According to this method, pixel data associated with a current block at an encoder side or coded data associated with the current block to be decoded at a decoder side are received in step 2410. In step 2420, the current block is partitioned into one or more sub-blocks, wherein said partitioning the current block comprises: signalling or parsing a first syntax, wherein the first syntax is indicative of whether to split the current block; and in response to the first syntax, signalling or parsing a second syntax, wherein the second syntax is indicative of one or more conditions comprising whether one of predefined partitions being applied to the current block. Said one or more sub-blocks are encoded or decoded in step 2430.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving pixel data associated with a current block at an encoder side or coded data associated with the current block to be decoded at a decoder side;
partitioning the current block into one or more sub-blocks, wherein said partitioning the current block comprises:
signalling or parsing a first syntax, wherein the first syntax is indicative of whether to split the current block; and
in response to the first syntax indicating the current block being split, signalling or parsing a second syntax, wherein the second syntax is indicative of whether to use a shortcut mode to indicate a target partition from predefined partitions directly; and
encoding or decoding said one or more sub-blocks.

2. The method of claim 1, further comprising in response to the second syntax indicating the shortcut mode being applied to the current block, signalling or parsing a third syntax to indicate one of the predefined partitions being applied to the current block.

3. The method of claim 2, further comprising, in response to the third syntax indicating said one of the predefined partitions being applied to the current block, signalling or parsing a fourth syntax for each of sub-blocks generated by applying said one of the predefined partitions to the current block to indicate whether said each of sub-blocks is further partitioned.

4. An apparatus for video coding, the apparatus comprising one or more electronics or processors arranged to:
receive pixel data associated with a current block at an encoder side or coded data associated with the current block to be decoded at a decoder side;
partition the current block into one or more sub-blocks, comprising:
signal or parse a first syntax, wherein the first syntax is indicative of whether to split the current block; and
in response to the first syntax indicating the current block being split, signal or parse a second syntax, wherein the second syntax is indicative of whether to use a shortcut mode to indicate a target partition from predefined partitions directly; and
encode or decode said one or more sub-blocks.

5. The apparatus of claim 4, wherein, in response to the second syntax indicating the shortcut mode being applied to the current block, said one or more electronics or processors arranged to further signal or parse a third syntax to indicate one of the predefined partitions being applied to the current block.

6. The apparatus of claim 5, wherein, in response to the third syntax indicating said one of the predefined partitions being applied to the current block, said one or more electronics or processors arranged to signal or parse a fourth syntax for each of sub-blocks generated by applying said one of the predefined partitions to the current block to indicate whether said each of sub-blocks is further partitioned.

7. A method of video coding, the method comprising:
receiving pixel data associated with a current block at an encoder side or coded data associated with the current block to be decoded at a decoder side;
partitioning the current block into one or more sub-blocks, wherein said partitioning the current block comprises:
signalling or parsing a first syntax, wherein the first syntax is indicative of whether to split the current block; and
in response to the first syntax, signalling or parsing a second syntax, wherein the second syntax is indicative of one or more conditions comprising whether one of predefined partitions being applied to the current block; and
encoding or decoding said one or more sub-blocks.

8. The method of claim 7, wherein when the second syntax corresponds to a particular value, the current block is not partitioned using any of the predefined partitions.

9. The method of claim 8, wherein the second syntax is signalled or parsed when the first syntax indicates the current block being split.

10. The method of claim 9, further comprising, in response to the second syntax indicating said one of predefined partitions being applied to the current block, signalling or parsing a third syntax for each of sub-blocks generated by applying said one of predefined partitions to the current block to indicate whether said each of sub-blocks is further partitioned.

11. The method of claim 9, wherein when the second syntax is equal to the particular value, the current block is partitioned using one or more partition types comprising QT (Quadtree) partition, MTT (Multi-Type Tree) partition, or a combination thereof.

12. The method of claim 8, wherein the second syntax is signalled or parsed when the first syntax corresponds to false.

13. The method of claim 12, further comprising, in response to the second syntax indicating said one of predefined partitions being applied to the current block, signalling or parsing a third syntax for each of sub-blocks generated by applying said one of predefined partitions to the current block to indicate whether said each of sub-blocks is further partitioned.

14. The method of claim 12, wherein when the second syntax is equal to the particular value, the current block is not partitioned.

15. The method of claim 7, wherein said one or more conditions further comprise whether QT (quadtree) partition being applied to the current block.

16. The method of claim 15, wherein when the second syntax corresponds to a first particular value, the current block is partitioned using QT (Quadtree) partition and when the second syntax corresponds to a second particular value, the current block is partitioned using MTT (Multi-Type Tree) partition.

17. An apparatus for video coding, the apparatus comprising one or more electronics or processors arranged to:
receive pixel data associated with a current block at an encoder side or coded data associated with the current block to be decoded at a decoder side;
partition the current block into one or more sub-blocks, comprising:
signal or parse a first syntax, wherein the first syntax is indicative of whether to split the current block; and
in response to the first syntax, signal or parse a second syntax, wherein the second syntax is indicative of one or more conditions comprising whether one of predefined partitions being applied to the current block; and
encode or decode said one or more sub-blocks.
